(19) United States
(12) Patent Application Publication
(10) Pub. No.: US 2005/0071545 A1
(43) Pub. Date: Mar. 31, 2005

(54) Method for embedding a server into a storage subsystem

(75) Inventors: Wayne Karpoff, Sherwood Park (CA); David Southwell, Sherwood Park (CA); Jason Gunthorpe, Edmonton (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: YottaYotta, Inc., Edmonton (CA)

(21) Appl. No.: 10/913,008

(22) Filed: Aug. 6, 2004

Related U.S. Application Data
(63) Continuation-in-part of application No. 10/046,070, filed on Jan. 11, 2002, now Pat. No. 6,857,059.
(60) Provisional application No. 60/493,964, filed on Aug. 8, 2003.
(60) Provisional application No. 60/261,140, filed on Jan. 11, 2001.

(51) Int. Cl. G06F 13/00; G06F 12/00; G06F 15/16

(52) U.S. Cl. 711/111; 709/203

(57) ABSTRACT

A server is embedded directly into a storage subsystem. When moving between the storage subsystem domain and the server domain, data copying is minimized. Data management functionality written for traditional servers is implemented within a stand-alone storage subsystem, generally without software changes to the ported subsystems. The hardware executing the storage subsystem and server subsystem can be implemented in a way that provides reduced latency, compared to traditional architectures, when communicating between the storage subsystem and the server subsystem. When using a plurality of clustered controllers, traditional load-balancing software can be used to provide scalability of server functions. One end-result is a storage system that provides a wide range of data management functionality, that supports a heterogeneous collection of clients, that can be quickly customized for specific applications, that easily leverages existing third party software, and that provides optimal performance.

### CROSS-REFERENCES TO RELATED APPLICATIONS

This application claims the benefit of U.S. provisional application No. 60/493,964 which is hereby incorporated by reference in its entirety. This application also claims priority as a Continuation-in-part of U.S. non-provisional application Ser. No. 10/046,070 which is hereby incorporated by reference in its entirety.

### BACKGROUND OF THE INVENTION

Traditionally, data management provided to end-consumer applications involves a variety of software layers. These software layers are normally split between storage subsystems, servers, and client computers (sometimes, the client computers and the servers may be embodied in a single computer system).

In a Storage Area Network (SAN) architecture, the division is typically set forth as described in FIG. 1. In FIG. 1, software functionality managing block related functionality, such as the block virtualization layer 134 and block cache management 136, are implemented on a separate storage subsystem. Higher-level functionality, such as file system functionality 124 and other data management functionality 122 is implemented on a traditional computer system operating as a server 102. Examples of data management functionality include databases, data life cycle management software, hierarchical storage management software, and specialized software such as PACCS software used in the medical industry. Various data management software systems may be used in combination with each other. Communication between the server 102 and the storage subsystem 104 involves industry standard protocols such as Fibre Channel 142 driven by layers of device drivers 126 and 128 on the server side and target drivers 130 and 132 on the storage subsystem side. This physical network 142 combined with layers of device drivers and target software adds considerable latency to I/O operations. Positioning the file system within the server makes heterogeneous operation a challenge as building a single file system that supports multiple operating systems is non-trivial.

What is commonly referred to as Network Attached File Systems (NAS), as shown in FIG. 2, moves most of the file system functionality 132 into the storage subsystem. Industry standard protocols, such as NFS and CIFS allow multiple operating systems to communicate to a single file system image. Thus multiple heterogeneous servers can share a single file system. Communication between the server 202 and the storage subsystem 204 typically uses common networks such as Ethernet.

### BRIEF SUMMARY OF THE INVENTION

According to the present invention, a server is embedded directly into a storage subsystem. When moving between the storage subsystem domain and the server domain, data copying is minimized. Data management functionality written for traditional servers may be implemented within a stand-alone storage subsystem, generally without software changes to the ported subsystems. The hardware executing the storage subsystem and server subsystem are implemented in a way that provides reduced or negligible latency, compared to traditional architectures, when communicating between the storage subsystem and the server subsystem. In one aspect, a plurality of clustered controllers are used. In this aspect, traditional load-balancing software can be used to provide scalability of server functions. One end-result is a storage system that provides a wide range of data management functionality, that supports a heterogeneous collection of clients, that can be quickly customized for specific applications, that easily leverages existing third party software, and that provides optimal performance.

According to an aspect of the invention, a method is provided for embedding functionality normally present in a server computer system into a storage system. The method typically includes providing a storage system having a first processor and a second processor coupled to the first processor by an interconnect medium, wherein processes for controlling the storage system execute on the first processor, porting an operating system normally found on a server system to the second processor, and modifying the operating system to allow for low latency communications between the first and second processors.

According to another aspect of the invention, a storage system is provided that typically includes a first processor configured to control storage functionality, a second processor, an interconnect medium communicably coupling the first and second processors, an operating system ported to the second processor, wherein said operating system is normally found on a server system, and wherein the operating system is modified to allow low latency communication between the first and second processors.

According to yet another aspect of the invention, a method is provided for optimizing communication performance between server and storage system functionality in a storage system. The method typically includes providing a storage system having a first processor and a second processor coupled to the first processor by an interconnect medium, porting an operating system normally found on a server system to the second processor, modifying the operating system to allow for low latency communications between the first and second processors, and porting one or more file system and data management applications normally resident on a server system to the second processor.

According to still another aspect of the invention, a method is provided for implementing clustered embedded server functionality in a storage system controlled by a plurality of storage controllers. The method typically includes providing a plurality of storage controllers, each storage controller having a first processor and a second processor communicably coupled to the first processor by a first interconnect medium, wherein for each storage controller, an operating system normally found on a server system is ported to the second processor, wherein said operating system is allows low latency communications between the first and second processors. The method also typically includes providing a second interconnect medium between each of said plurality of storage controllers. The second communication medium may handle all inter-processor communications. A third interconnect medium is provided in some aspects, wherein inter-processor communications between the first processors occur over one of the second and third mediums and inter-processor communications between the second processors occur over the other one of the second and third mediums.

According to another aspect of the invention, a storage system is provided that implements clustered embedded server functionality using a plurality of storage controllers. The system typically includes a plurality of storage controllers, each storage controller having a first processor and a second processor communicably coupled to the first processor by a first interconnect medium, wherein for each storage controller, processes for controlling the storage system execute on the first processor, an operating system normally found on a server system is ported to the second processor, wherein said operating system is allows low latency communications between the first and second processors, and one or more file system and data management applications normally resident on a server system are ported to the second processor. The system also typically includes a second interconnect medium between each of said plurality of storage controllers, wherein said second interconnect medium handles inter-processor communications between the controller cards. A third interconnect medium is provided in some aspects, wherein inter-processor communications between the first processors occur over one of the second and third mediums and inter-processor communications between the second processors occur over the other one of the second and third mediums.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates traditional storage area network (SAN) software towers.

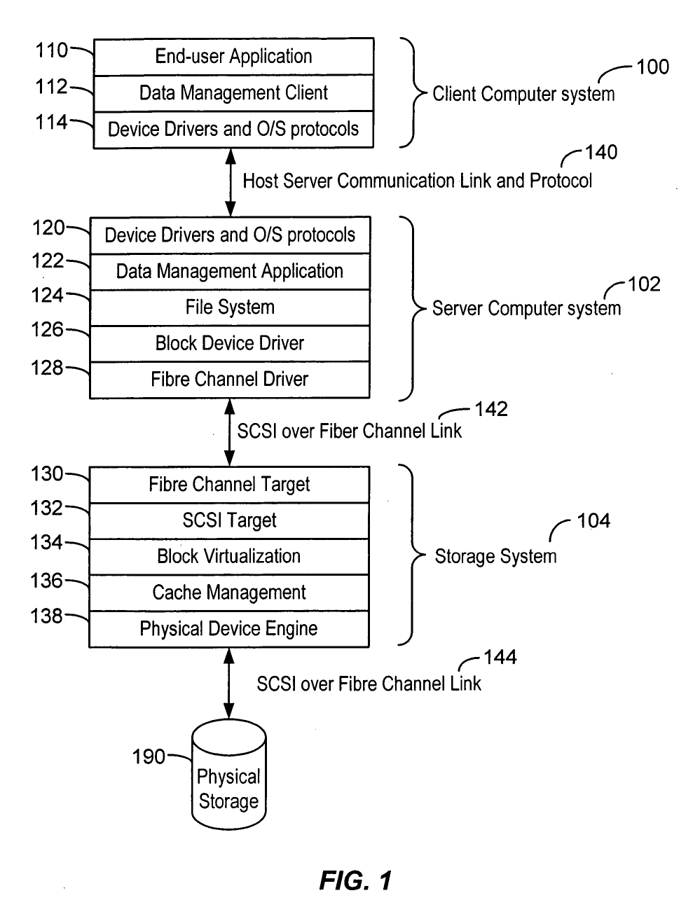

FIG. 2 illustrates traditional network attached storage (NAS) software towers.

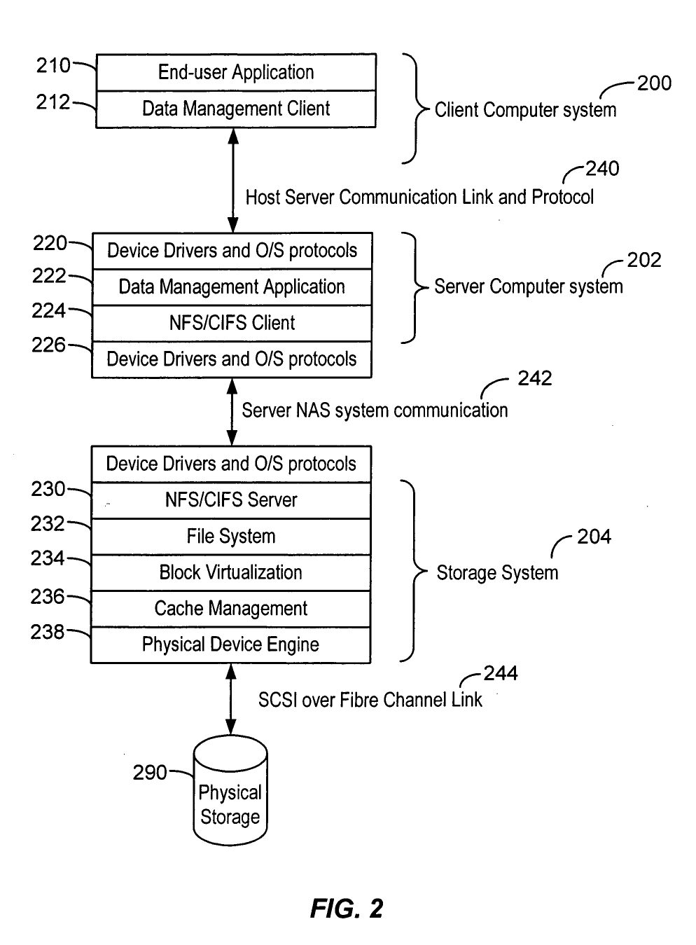

FIG. 3 illustrates a server tower embedded in a storage system, such as a storage controller node, according to one embodiment of the present invention.

FIG. 4 illustrates embedded server hardware in a storage system, such as a storage controller node, according to one embodiment of the present invention.

FIG. 5 illustrates an alternate I/O module supporting Infiniband according to one embodiment of the present invention.

FIG. 6 illustrates an alternate I/O module supporting 8-Gigabit Ethernet ports according to one embodiment of the present invention.

FIG. 7 illustrates embedded server software modules according to one embodiment.

FIG. 8 illustrates a memory allocation scheme according to one embodiment.

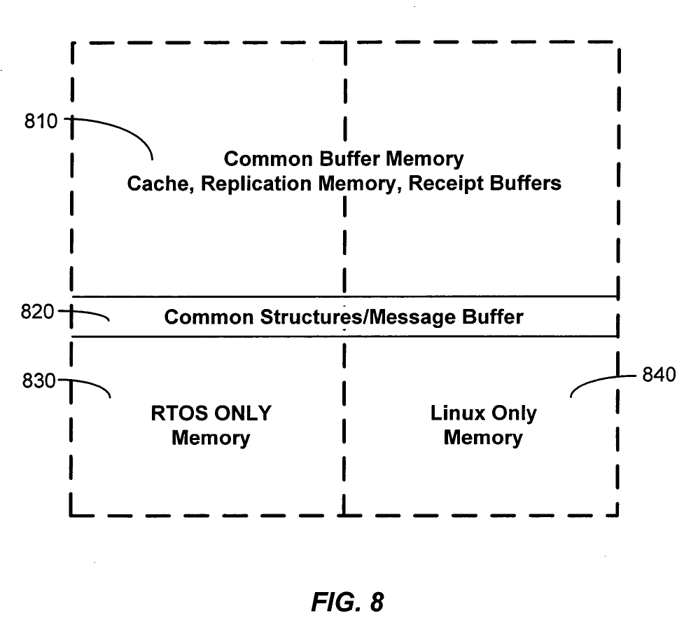

### DETAILED DESCRIPTION OF THE INVENTION

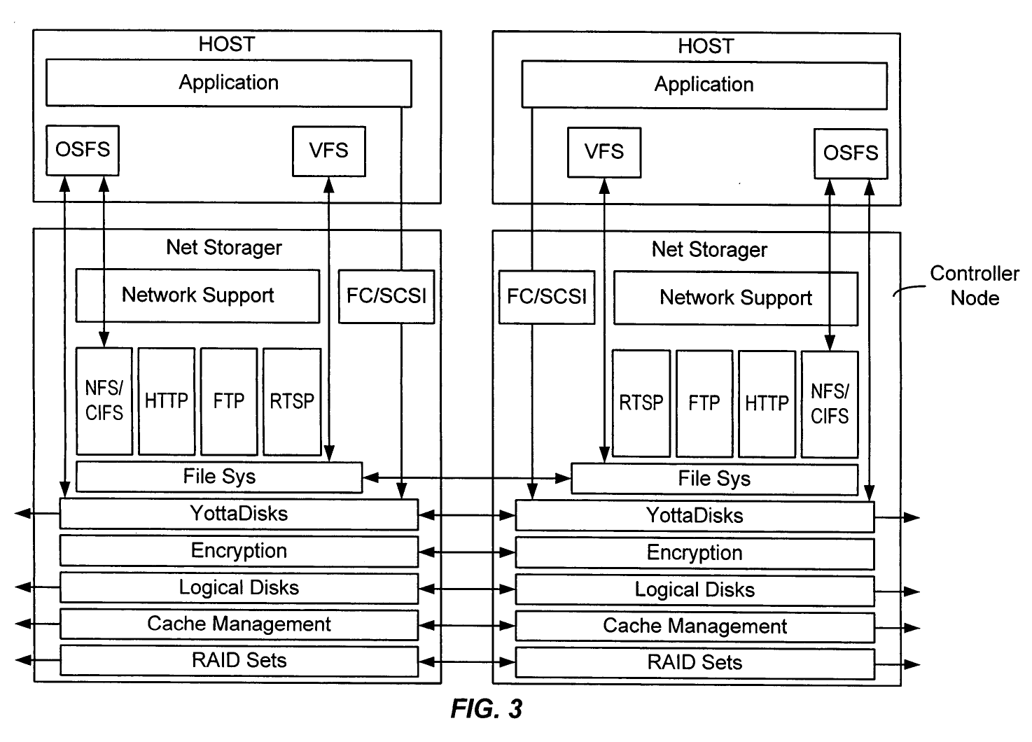

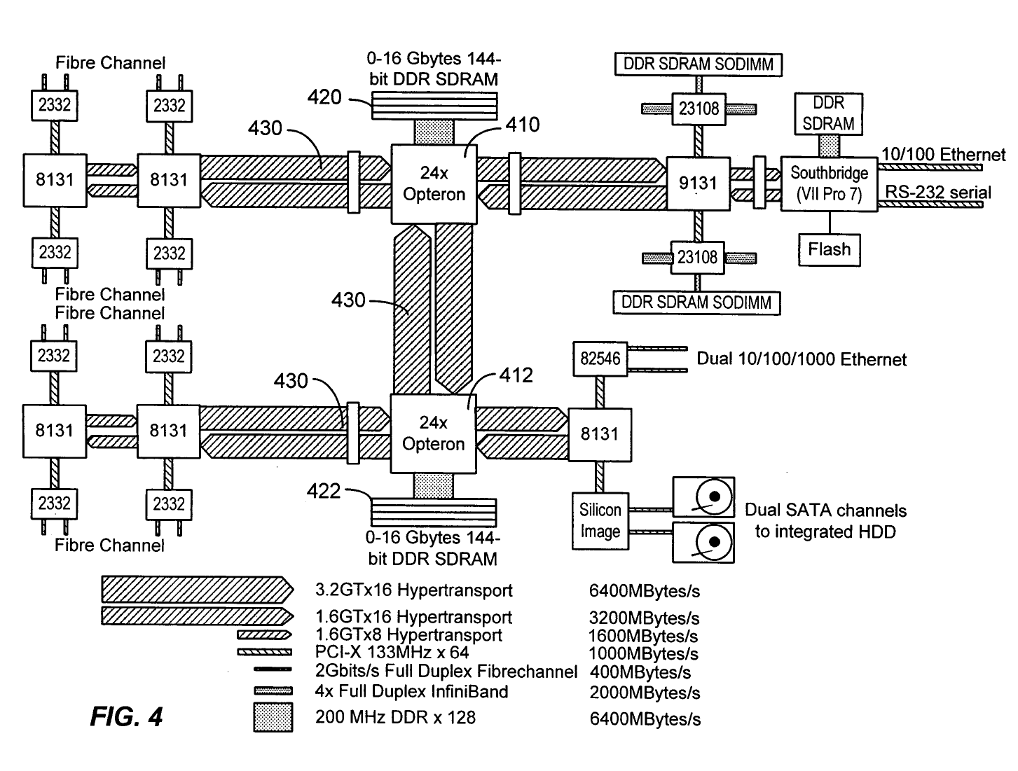

According to one embodiment all, or a substantial portion, of the data management functionality is moved within the storage subsystem. In order to maximize the utilization of existing software, including third party software, and to minimize porting effort, in one aspect, the data management functionality is implemented as two separate software towers running on two separate microprocessors. While any high speed communication between the processors could be used, a preferred implementation involves implementing hardware having two (or more) microprocessors that are used to house a storage software tower and a server software tower, but allowing each microprocessor having direct access to a common memory. An example of a server tower embedded in a storage system according to one embodiment is shown in FIGS. 3 and 4. In FIG. 4, both processors 410 and 412 can access both banks of memory 420 and 422 via the HyperTransport™ bus 330. The HyperTransport™ architecture is described in http://www.hypertransport.org/tech_specifications.html, which is hereby incorporated by reference. It will be apparent to one skilled in the art that alternate bus architectures may be used, such as Ethernet, a system bus, PCI, proprietary networks and busses, etc. Collectively, the processors 410 and 412, bus 430 and memory 420 and 422 in FIG. 4 are implemented in a single storage controller node, e.g., in a single NetStorager™ controller card as shown in FIG. 3, according to one embodiment.

It will be apparent to one skilled in the art that multi-processor chip implementations may be used to accomplish a similar architecture. It will also be apparent to one skilled in the art that processor virtualization software can be used to emulate two separate processors executing a single ‘real’ processor. It will also be apparent that the software tower can run as a task of the server tower.

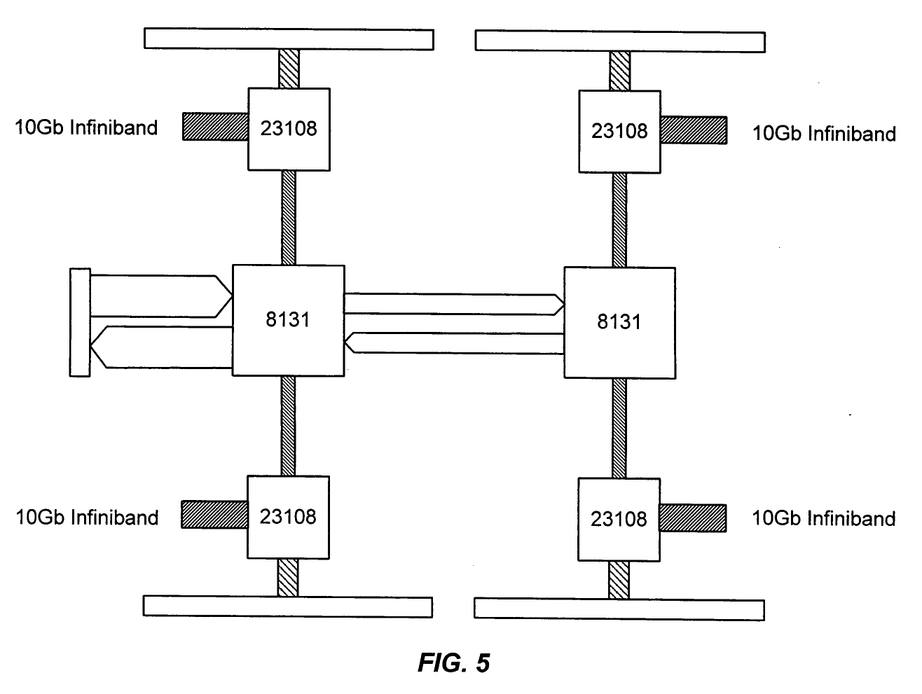

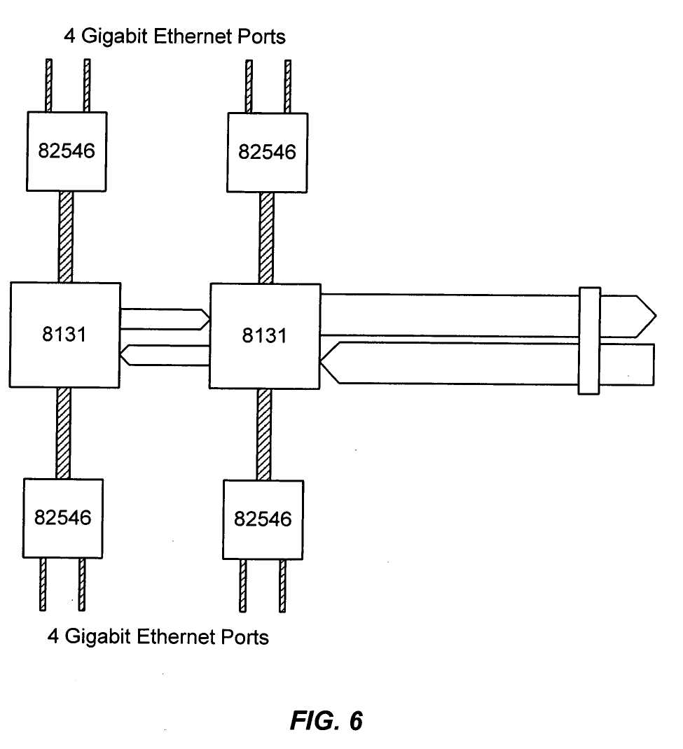

In a preferred implementation, connectors 430 are used to connect the I/O portions of the hardware. This allows alternate I/O modules to be used to provide alternate host protocol connections such as InfiniBand®, e.g. as shown in FIG. 5, or to increase Ethernet connectivity, e.g. as shown in FIG. 6. The preferred implementation allows resulting I/O ports to be assigned to either software tower as desired.

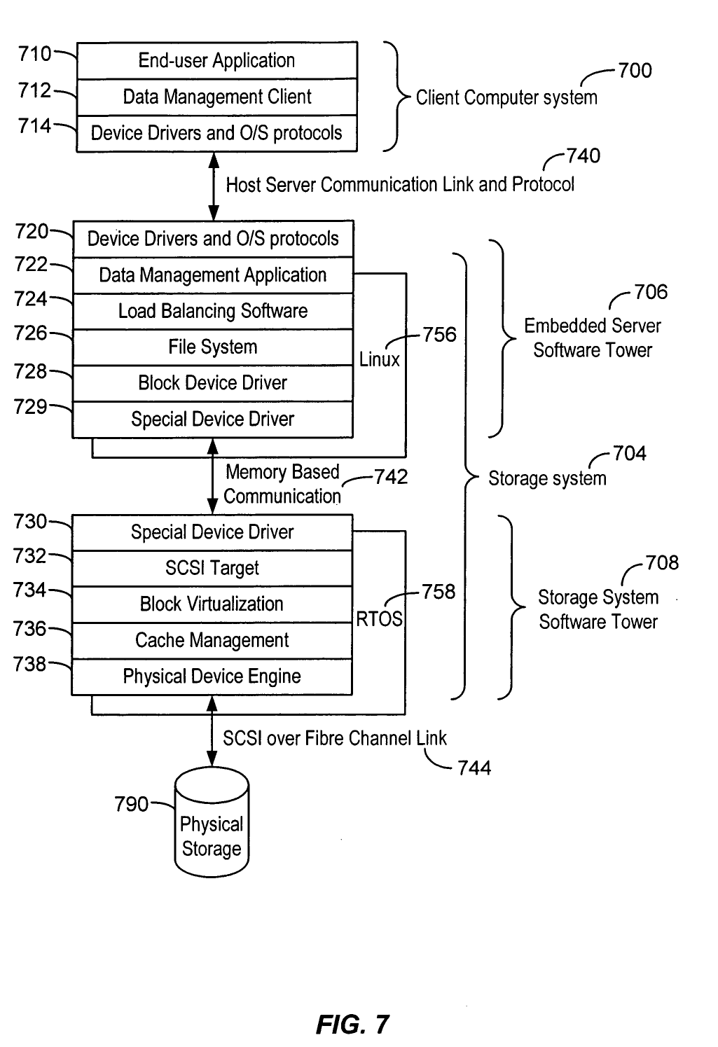

According to one embodiment, as shown in FIG. 7, in addition to the standard storage system software tower 708, which typically executes on a storage system processor, e.g. processor 310 of FIG. 4, a second tower that normally runs on an external server 706 is placed on the second processor, e.g., processor 412 of FIG. 4. A traditional operating system, such as Linux 756 is ported to the second processor and used to host the overlying software layers. This allows easy adoption, usually without modification, of existing software designed for a traditional server environment.

According to one embodiment, the common memory, e.g., memory 420 and 422 of FIG. 4, is partitioned into two regions, one for each software tower. In one aspect, a small common region is reserved for managing data structures involved with inter-processor communications. In this example, a two-way mailbox algorithm is used in one aspect for communicating between the “shared memory device drivers” running on each of the two processors as follows. Each processor maintains a work queue for the other processor. Only the initiator links work onto the end of the queue. When one processor “A” needs to message processor “B” of a communication, the following steps occur in one aspect:
1. Processor A (the initiator) allocates a control block from its own memory space.
2. Processor A sets the “completed” flag to false.
3. Processor A fills in other fields as required by the request.
4. Processor A links the request on the end of a linked list of requests destined for processor B.
5. Processor A notifies processor B via an interrupt or event trap of the presence of work in the queue.
6. Processor B starts at the top of the queue processing uncompleted requests. When a request is completed, Processor B sets the respective “completed” flag to True and provides an interrupt to Processor A.
7. Processor A begins at the top of the queue, noting which transactions have been completed and unlinking them. The order of storing addresses is important to ensure that transactions can be unlinked without a semaphore.

According to one aspect, an integer field representing priority is included and the link is scanned multiple times looking for decreasing priorities of requests.

In one aspect, data buffers are pre-allocated by the request target and can be used by the source processor to receive actual data. In this aspect, the processor initiating the request is responsible for copying the data blocks from its memory to the pre-allocated buffer on the receiving processor.

According to another aspect, the actual data coping is deferred until deemed more convenient, thus minimizing latency associated with individual transactions. This is preferably done without modifications outside the device driver layer of the Linux operating system; e.g. during a write operation, by “nailing” the I/O page to be written and using the Linux page image for the I/O operations in the storage system. The page can be replicated as a background function on the Storage System processor (the processor implementing storage system control functionality). When the copy is complete and in use by the Storage System, the Server Device Driver is notified that the page is now “clean” and can be “un-nailed.”

In one aspect, all of the above is implemented on the Server processor (the processor implementing server functionality) using a special device driver.

According to one aspect, the virtual memory management modules of both the Sever operating system and the storage system work cooperatively in using common I/O buffers, thus advantageously avoiding unnecessary copies and minimizing the redundancy of space usage.

In order to prevent defective software from making unauthorized writes, the memory management units (MMUs) from both processors are used to protect memory not currently assigned to the respective processor.

In one embodiment, multiple storage system controller nodes are clustered together. The concept of clustering controllers was introduced in U.S. Pat. No. 6,148,414. Additional refinements of clustered controllers were introduced in US Application No. 2002/0188655. U.S. Pat. No. 6,148,414 and US Application No. 2002/0188655, which are each hereby incorporated by reference in its entirety, teach how to make multiple storage system towers work cooperatively, how to load-balancing their workloads, and how to make their respective caches coherent even though they are implemented on separate physical memories. One advantageous result of implementing aspects of the present invention in multiple storage system controllers is that multiple Storage System Towers can export a given virtual volume of storage to multiple embedded servers. The performance scales as additional Storage System towers are added. Clustered file systems are now common, wherein multiple file system modules running on multiple servers can export to their host a common file system image. An example of a clustered file system is the Red Hat Global File System (http://www.redhat.com/software/rha/gfs/). If the file system 726 (FIG. 7) chosen is a clustered file system, then software layers above the file system, regardless what controller they are residing on, will see a common file system image. Data Management Applications 722 that support multiple invocations to a single file image will now scale as more storage controller modules are added. Examples of software that can benefit from this environment include web servers and parallel databases. I/O intensive applications, such as data mining applications, obtain significant performance benefits from running directly on the storage controller.

In one aspect, the file system allocates its buffer space using the common buffer allocation routines described above. The buffers are the largest storage consumer of a file system. Allocating them from the common pool 810, rather than the Server Tower specific pool 840, optimizes the usage of controller memory and makes the overall system more flexible.

Porting common software that balances application software execution load between multiple servers, such as LSF from Platform computing, onto the server tower 724 allows single instance applications to benefit from the scalability of the overall platform. The load-balancing layer 724 moves applications between controllers to balance the execution performance of controllers and allow additional controllers to be added to a live system to increase performance.

While the invention has been described by way of example and in terms of the specific embodiments, it is to be understood that the invention is not limited to the disclosed embodiments. To the contrary, it is intended to cover various modifications and similar arrangements, in addition to those discussed above, as would be apparent to those skilled in the art. For example, although two processors were discussed, the present invention is applicable to implementing more than two processors for sharing server and or storage system control functionality on any given node. Therefore, the scope of the appended claims should be accorded the broadest interpretation so as to encompass all such modifications and similar arrangements.

1. A method of embedding functionality normally present in a server computer system into a storage system, the method comprising:
providing a storage system having a first processor and a second processor coupled to the first processor by an interconnect medium, wherein processes for controlling the storage system execute on the first processor;
porting an operating system normally found on a server system to the second processor; and
modifying the operating system to allow for low latency communications between the first and second processors.

2. The method of claim 1, wherein the first and second processors share access to a common memory pool, the method further including using the common memory pool as a communication medium between the first and second processors.

3. The method of claim 2, further including dynamically allocating memory in the common memory pool between the first and second processors.

4. The method of claim 2, further including concurrently sharing at least a portion of the common memory between the first and second processors, said portion for storing data structures.

5. A storage system, comprising:
a first processor configured to control storage functionality;
a second processor;
an interconnect medium communicably coupling the first and second processors; and
an operating system ported to the second processor, wherein said operating system is normally found on a server system, and wherein the operating system is modified to allow low latency communication between the first and second processors.

6. The storage system of claim 5, further comprising a common memory pool accessibly by both the first and second processors.

7. The storage system of claim 6, wherein the first and second processors communicate using the common memory pool.

8. The storage system of claim 6, wherein memory in the common pool is dynamically allocated between the first and second processors.

9. The storage system of claim 6, wherein the first and second processors concurrently share at least a portion of the common memory pool, said portion for storing data structures.

10. The storage system of claim 5, wherein the first and second processors are physically located on a single controller card.

11. The storage system of claim 5, wherein the first and second processors are physically located on separate controller cards.

12. The storage system of claim 5, wherein the interconnect medium comprises one of a PCI bus, and Infiniband bus, a Fibre Channel bus, and a HyperTransport bus.

13. A method of optimizing communication performance between server and storage system functionality in a storage system, the method comprising:
providing a storage system having a first processor and a second processor coupled to the first processor by an interconnect medium;
porting an operating system normally found on a server system to the second processor;
modifying the operating system to allow for low latency communications between the first and second processors; and
porting one or more file system and data management applications normally resident on a server system to the second processor.

14. The method of claim 13, wherein the first and second processors share access to a common memory pool, the method further including using the common memory pool as a communication medium between the first and second processors.

15. The method of claim 14, further including concurrently sharing at least a portion of the common memory between the first and second processors, said portion for storing data structures.

16. The method of claim 14, further including dynamically allocating memory in the common memory pool between the first and second processors.

17. A method of providing clustered embedded server functionality in a storage system controlled by a plurality of storage controllers, the method comprising:
providing a plurality of storage controllers, each storage controller having a first processor and a second processor communicably coupled to the first processor by a first interconnect medium, wherein for each storage controller, an operating system normally found on a server system is ported to the second processor, wherein said operating system is allows low latency communications between the first and second processors; and
providing a second interconnect medium between each of said plurality of storage controllers.

18. The method of claim 17, further comprising providing a third interconnect medium between each of the plurality of storage controllers, wherein inter-processor communications between each of the first processors occur on the second interconnect medium, and wherein inter-processor communications between each of the second processors occur on the third interconnect medium.

19. The method of claim 18, wherein the second and third interconnect mediums include one of Infiniband medium an Ethernet medium a Fibre Channel medium, a shared memory, and a proprietary network.

20. The method of claim 17, wherein the first interconnect medium includes a system bus.

21. The method of claim 17, for each storage controller, a software module is provided on the second processor that is configured to balance the load among the second processors by starting applications on the second processors based on the loads on the second processors.

22. The method of claim 21, wherein the load is balanced among the second processors by moving active tasks between second processors.

23. A storage system that provides clustered embedded server functionality using a plurality of storage controllers, the system comprising:
a plurality of storage controllers, each storage controller having a first processor and a second processor communicably coupled to the first processor by a first interconnect medium, wherein for each storage controller:
processes for controlling the storage system execute on the first processor;
an operating system normally found on a server system is ported to the second processor, wherein said operating system allows low latency communications between the first and second processors; and
one or more file system and data management applications normally resident on a server system are ported to the second processor; and
a second interconnect medium between each of said plurality of storage controllers, wherein said second interconnect medium handles inter-processor communications between the controller cards.

24. The system of claim 23, further comprising a third interconnect medium between each of the plurality of storage controllers, wherein inter-processor communications between each of the first processors occur on the second interconnect medium, and wherein inter-processor communications between each of the second processors occur on the third interconnect medium.

25. The system of claim 24, wherein the second and third interconnect mediums each include one of Infiniband medium an Ethernet medium a Fibre Channel medium, a shared memory, and a proprietary network.

26. The system of claim 23, wherein the first interconnect medium includes a system bus.

27. The system of claim 23, further including, for each storage controller, a software module provided on the second processor, said module being configured to balance the load among the second processors by starting applications on the second processors based on the loads on the second processors.

28. The system of claim 27, wherein the load is balanced among the second processors by moving active tasks between second processors.

29. A method for providing scalable Web services wherein a Web server application is ported to one or more second processors in the system of claim 27.

30. A method for embedding a parallel database into a storage subsystem wherein a parallel data base engine is ported to one or more second processors in the system of claim 23.

31. A method for embedding a non-parallel database into a storage subsystem wherein multiple instances of a non-parallel database are ported to one or more second processors in the system of claim 28.

32. A method for increasing the performance of input/output intensive applications wherein instances of the application are executed on one or more second processors in the system of claim 23.

33. A method for increasing the performance of a data mining operation wherein the data mining algorithms are executed on one or more second processors in the system of claim 23.

34. A method for providing scalable Web services wherein a Web server application is ported to one or more second processors in the system of claim 23.
